(19) United States
(12) Patent Application Publication
(10) Pub. No.: US 2003/0233634 A1
(43) Pub. Date: Dec. 18, 2003

(54) Open debugging environment

(76) Inventors: Stephane Carrez, Issy Les Moulineaux (FR); Guennadi Maslov, Rucil Malmaison (FR); Adam Mirowski, Le Chesnay (FR)

Correspondence Address: B. Noel Kivlin, Conley, Rose, & Tayon, P.C., P.O. Box 398, Austin, TX, 78767, US

(21) Appl. No.: 10/171,081

(22) Filed: Jun. 13, 2002

(51) Int. Cl. G06F 9/46; G06F 9/44

(52) U.S. Cl. 717/124

(57) ABSTRACT

The environment is based on a computer system, comprising a target and a host, including a debugger, capable of issuing commands to obtain information on the target. The host further has a server, capable of communicating with the target, generally through a target agent, to access target condition data concerning target objects. The server has a server module for elaborating, maintaining and giving access to an object-oriented tree representation of the target objects. The target condition data are attributes of the target objects, each of which also has available operations and methods. A survey tool interface is capable of answering at least some of the debugger commands with information derived from said tree representation. The commands are converted into available operations.

### BACKGROUND OF THE INVENTION

This invention relates to computer technology.

The operating system (OS) named ChorusOS (SUN MICROSYSTEMS, ST QUENTIN EN YVELINES, France) is a real time embedded OS, flexible as to the hosting hardware. It provides efficient and reliable communication facilities between computers. This implies that it has to be installed and configured on a variety of computer platforms.

### SUMMARY OF THE INVENTION

This invention intends to provide an open debugging environment for platforms using such an operating system.

Basically, the open debugging environment is a computer system, comprising a target (to be debugged) and a debugging host, with in said host, a survey tool, capable of issuing commands to obtain information on said target.

In accordance with a feature of this invention, the host further has a server, capable of communicating with said target.

In accordance with another feature of this invention, the server has:

a server module for elaborating and maintaining an object-oriented representation of the target condition, and

a survey tool interface, including an adapting module for adapting said survey tool to said object oriented representation.

In accordance with a further feature of this invention, the server module is arranged for elaborating and maintaining an object-oriented representation of target objects, with each target object having attributes for storing corresponding target condition data, and with a correspondence between each target object and corresponding available operations. Thus, the survey tool interface may be made capable of answering at least some of said commands with information derived from said object-oriented representation of the target objects.

The invention may also be defined as a method of surveying a target in a computer system. The method comprises the steps of:

a) providing a survey tool in a host,

b) providing said host with a server, capable of communicating with said target,

c) in said server:

c1) elaborating and maintaining an object-oriented representation of said the target condition, and

c2) providing a survey tool interface, capable of adapting said survey tool to said object oriented representation.

Preferably, the target comprises a target agent, acting as a server for said server module as a client.

The invention also includes the software code portions being used, including code adapted to implement the above mentioned step c) and/or the above mentioned server module and survey tool interface, and/or code adapted to implement one or more target agents.

### BRIEF DESCRIPTION OF THE DRAWINGS

Other features and advantages of the invention will appear in the detailed description below and in the appended drawings, in which:

FIG. 1 shows a host computer and a target computer, interconnected via a serial line, according to a first embodiment of this invention;

FIG. 2 diagrammatically shows a host computer interconnected with target computers in a different fashion, according to alternative embodiments of this invention;

FIG. 3 shows in more detail the software sections of the host computer in FIGS. 1 and 3, including language dependent features;

FIG. 3A shows in still greater detail the software sections of the host computer in FIGS. 1 and 3, in a functional fashion;

FIG. 4 is a graphical representation of a first tree structure used in accordance with this invention;

FIG. 5 is a graphical representation of a second tree structure used in accordance with this invention;

FIG. 6 shows the basic flow chart of a debugging process;

FIG. 7 is a graphical representation of a third tree structure used in accordance with this invention;

FIG. 8 is a graphical representation of an instantiated portion of the third tree structure, showing associated attributes;

FIG. 9 is a graphical representation of an instantiated portion of the third tree structure, showing associated methods; and

FIG. 10 is a graphical representation of an instantiated portion of the third tree structure, showing associated event channels.

Additionally, the detailed description is supplemented with exhibits, in which:

Appendix I is essentially a table, showing relations between operations and events;

Appendix II is an example, showing code to access objects useful for the debugging of a process or actor; and

Appendix III shows code in IDL language.

As usual in such a case, the Exhibits use special typographic conventions, as necessary.

The Figures and Appendices include graphical and/or code information, which are useful to define the scope of this invention.

### DETAILED DESCRIPTION

Making reference to software entities imposes certain conventions in notation. In the detailed description:

the quote sign “ may be used as character string delimiter wherever deemed necessary for clarity (e.g. “actor”),

where there exists an abbreviation of a name or expression, square brackets may be used to frame the optional portion of the name (e.g. “[OS] archive”).

The detailed description hereinafter refers to platforms based on the ChorusoS operating system, and uses the corresponding terminology. This is exemplary only and it should be understood that the invention is applicable to a variety of computer platforms. Generally ChorusOS has the following abilities:

work with various processors and various main boards, adapted to specific products;

be loadable in RAM from a so called “[OS] archives” or “[OS] image file”, stored e.g. in persistent memory or as a file on the hard disk, depending upon the actual platform architecture;

define independent processes (named “actors”), exchanging messages;

enable the actors to communicate via an Interprocess Communication Service (IPC), which may be hidden.

For being installed on a particular machine (“target”), ChorusOS has to be prepared in accordance with the target characteristics, including its main board, the corresponding board support package (BSP), and its specific drivers. In view of the potential variety of possible target platforms, the need for debugging at this “system level” is clear. Later on, application debugging or “user debugging” may be needed. The newly proposed debug architecture addresses both system and user debug.

A purpose of this invention is to extend the existing debugging tools in order to offer a consistent tool environment providing system debug capabilities to allow debugging a system having its own board support package (BSP) and specific drivers. Furthermore, in the early OS installation phase, system debugging often implies the use of hardware equipment which provide different debugging facilities such as In Circuit Emulators (ICE), Background Debug Mode (BDM) or Join Test Action Group (JTAG).

The newly proposed debugging architecture is intended to be open to the integration of debuggers from different origins, and also to the integration of other similar tools such as profilers, monitoring and browsing tools, all hereinafter referred to, together with debuggers, as “survey tools”.

Reference is made to the following documents:

“Sun Embedded Workshop, ChorusOS Technical Overview”, CS/TR-96-119, SUN MICROELECTRONICS, Palo Alto, Calif. 94303, USA.

GDB User's Guide, published by the Free Software Foundation,

XRAY User's Guide, published by MICROTEC,

MULTI User's Guide, published by GREEN HILLS,

DWARF Debugging Information Format, Revision 2.0, Jul. 27, 1993, Unix International, PARSIPPANY, N.J. 07054, USA.

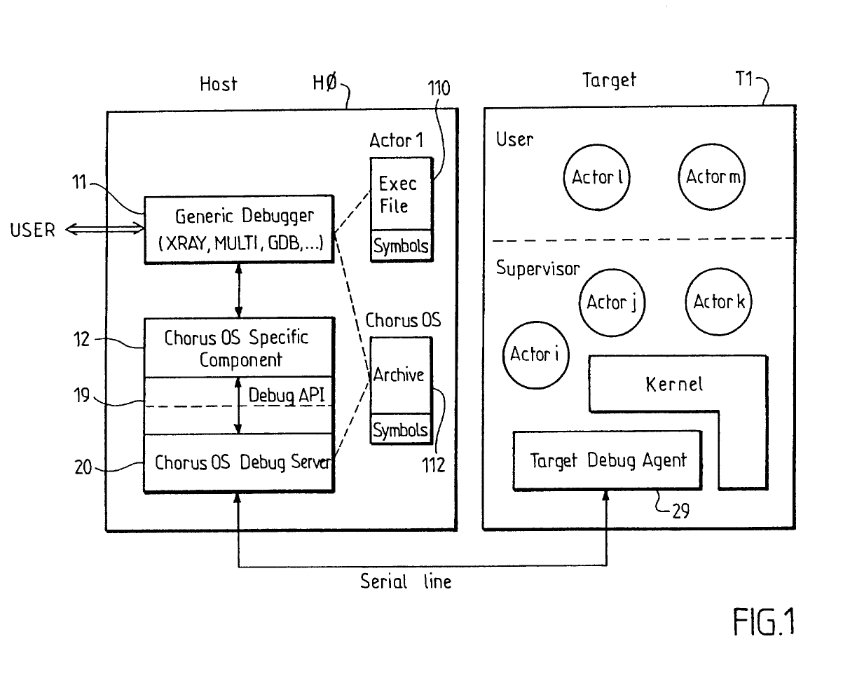

The open and dynamic debug architecture comprises four components operating between a host and a target, as shown in FIG. 1.

Component 11 (“Generic Debugger”) is a symbolic debugger, e.g. XRAY (Microtec, USA), delivering the debugging information from a standard format (e.g. DWARF-2). Other debuggers such as GNU/GDB, or MULTI (Green Hills, USA) may also be also used, as well as any other survey tool (Trademarks and trade names are used in this description as necessary to correctly identify existing products). The Generic Debugger 11 is under control of the debugging personnel (“user”). It uses the ChorusOS executable files in the host to obtain the debugging information of user applications, as illustrated in 110 (“actor 1”). For system debug, it uses the ChorusOS executable files or the ChorusOS archive (112).

Tightly coupled with Generic Debugger 11 is a Debug/OSAdapter 12. In the example, this is a ChorusOS specific component 12. Its function is to adapt the generic debugger to the ChorusOS specific objects (actors, threads, ports, messages, . . . ). If the source code for the generic debugger 11 is available (GNU/GDB), the generic debugger 11 and its specific component 12 may be merged within a single process; otherwise, generic debugger 11 (like XRAY and MULTI) and the corresponding ChorusOS specific component 12 are implemented as different processes in the host HO. The interface and communication methods between Generic Debugger 11 and OS-Adapter 12 may be proprietary and are different for each potential Generic Debugger. Considered together, generic Debugger 11 and OS-adapter 12 are termed “adapted debugger”.

Generally, Debug Server 20 provides the “adapted debugger” with a set of debug APIs and invocation methods available for C/C++or Java applications. However, other languages may be used as well. The target T1 (a target main board running ChorusOS) has a kernel and processes or actors, including supervisor actors and user actors, as known under ChorusOS.

Debug Server 20 answers requests from the “adapted debugger”, while hiding all details of the communication protocol between the host computer H0 and the target T1. It manages multiple connections to the same target, as well as multiple targets connected to the same host.

The commands which are requested by debuggers or other survey tools comprise the following “minimal low level operations” (in the target T1):

Read Memory, at least, for pure system analysis (passive debugging)

Write memory, Resume execution, Stop execution (both related to execution semantics), may be used for setting breakpoints, stopping and resuming execution, as required for interactive debugging.

For full capability, the target T1 is provided with a target debug agent 29. Basically, target Debug Agent 29 may be viewed as a part (usually small) of the debug code, running on the target main board. The interconnection between the Debug Server and the Debug Agent is made through a serial line, as known.

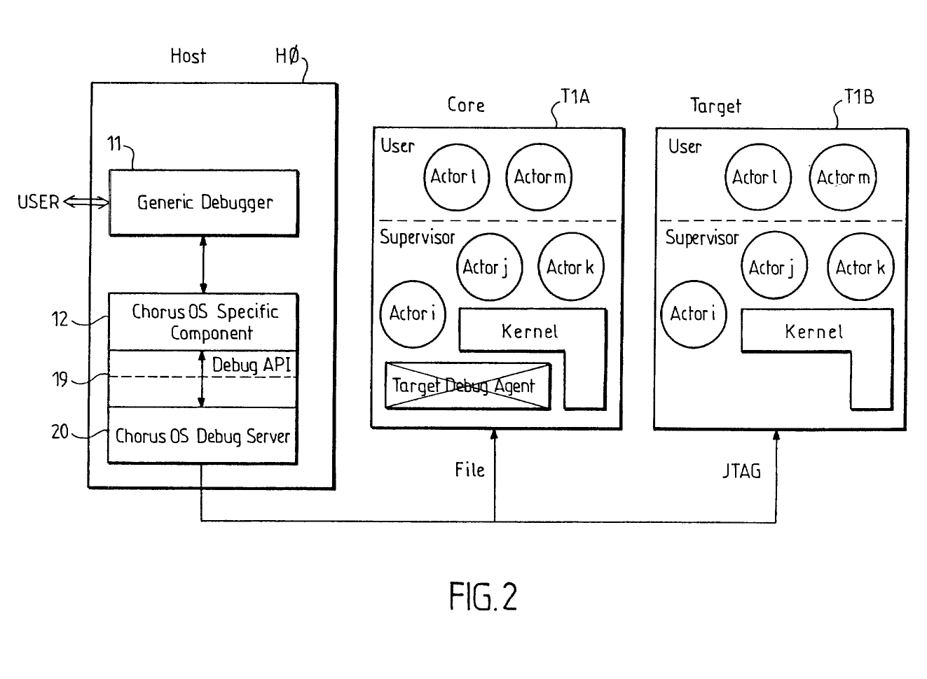

However, debug server 20 first supports (FIG. 2) basic configurations in which no debug agent 29 is used (or available). In this mode, the debug Server 20 will directly execute the above mentioned minimal low level operations in the target. This mode is adequate at least in two cases:

a) The first case is when the Debug server 20 is operating on a target core file (FIG. 2, T1A), i.e. at the fundamental OS level, thus short circuiting the target debug agent (if any). A core file is the memory dump onto disk (or other mass memory), that the machine produces upon a crash. In this case, Debug Server 20 may only access the memory by reading the core file. Operations which have execution semantics are not provided.

b) The second case is when the Debug server 20 is accessing the target e.g. through a JTAG (FIG. 2, T1B) or BDM interface, which have the potentiality of stopping and restarting the processor. All the above actions or operations (Read Memory, Write memory, Resume execution, Stop execution) are provided and may be performed by the Debug Server 20 (supported by JTAG—or BDM—for all execution semantics). This may be used where the target should not execute extra code while being debugged.

Otherwise, using target debug agent 29 is preferred, at least in a minimal configuration. Debug agent 29 acts as a server, for which debug server 20 is a client (The server function of debug server 20 is valid mainly within the host). Thus, the Debug Agent 29 normally runs in slave mode. No synchronous upcall from the Debug Agent to the Debug Server should norammly occur. However, the Debug Agent may generate asynchronous events, in the form of alert/signal messages to inform the Debug Server of certain important events such as breakpoint hit, target stop or exception.

The minimal debug agent comprises the above mentioned “minimal low level operations”, plus (for full debugging) the processing of “exceptions”, since the debug agent has to catch exceptions such as bus errors, single step mode and breakpoints. It will then send an asynchronous “event” to the DebugServer and stop execution. The Debug Server will analyze the exception and will restart the system.

Optionally, other asynchronous events may be used if it is desired to provide the host with a remote view of the target console.

The Debug Server 20 uses information related to OS implementation on the target. This type of OS debugging information is used internally in the set of APIs. For example, the ChorusOS archive of the target board is used to obtain the ChorusOS variables, ChorusOS types, and other OS related information.

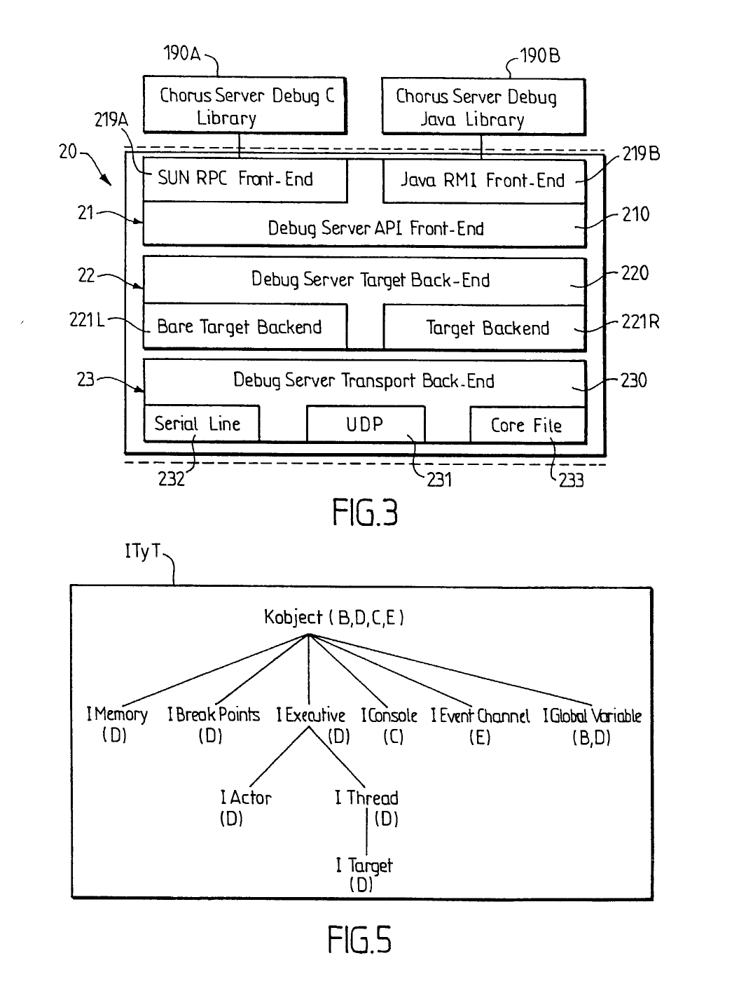

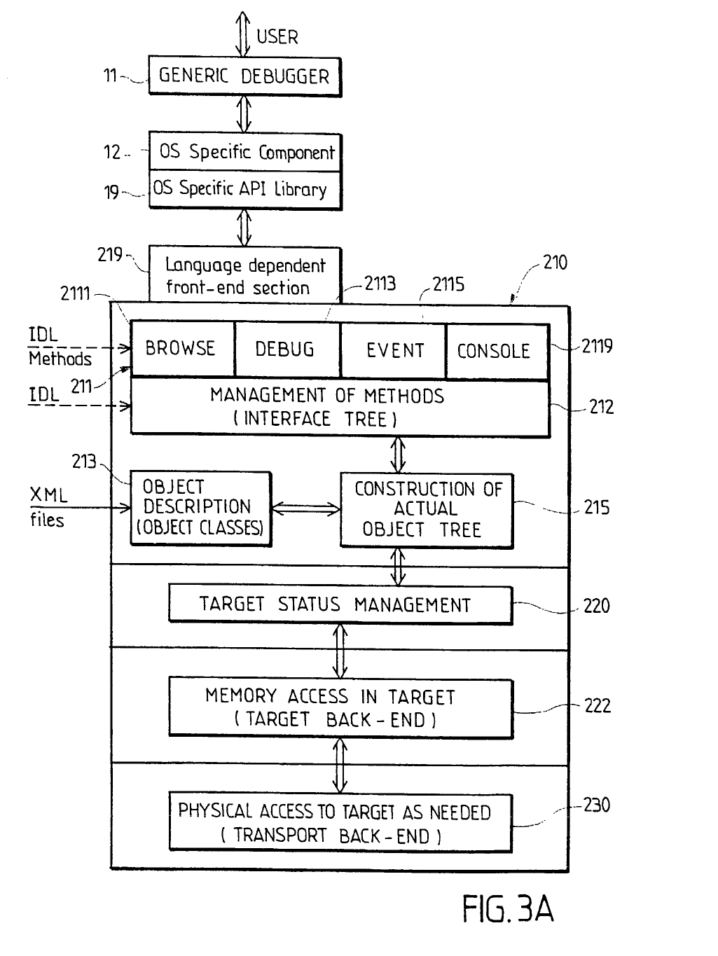

An exemplary Debug Server Architecture in accordance with the invention is shown in FIG. 3 and 3A. The Debug Server itself 20 is internally split into several parts: a front-end section 21, a back-end section 22 and a transport backend section 23. This organization improves the flexibility of the debug server.

The set of APIs comprises an OS-specific API library 19 (or “debug API”), and main debug APIs 211 included within front-End section 21. The debug library 19 provides the APIs for the OS specific components 12. It takes into account all the communication aspects between the Generic debugger 11 and the Debug Server 20. The library 19 is normally adapted to a particular language:

in 190A is shown a C library which can be used in C and C++, communicating with an RPC (Remote Procedure Call) based front-end 219A. The RPC front-end manages communication between the Generic debugger 11 and DebugServer 20. It completely hides the communication mechanism and adapts the C library requests to the common front-end.

alternatively, a Java API library 190B may be provided. It communicates with a Java front-end 219B, provided to allow Java survey tools to access the debug server 20. This front-end uses Java RMI (Remote Method Invocation, the equivalent of RPC in Java) to communicate with Java survey tools. This front-end uses the Java virtual machine and the Java RMI library to accept RMI requests from Java clients. It adapts the Java requests to the common front-end.

Then, in front-end section 21, a common front-end section 210 comprises, as a runtime or executive part:

main debug APIs 211, i.e. the basic “browse” 2111, “Debug” 2113, “Event” 2115 and, optionally, “Console” 2119,

a method management section 212,

a set of predefined object classes 213, and

a module 215 for constructing an actual object tree, following the sequence of the debugging operations.

The common front-end 210 uses the back-end section 22 to implement specific and/or complex operations such as browsing the objects, setting breakpoints, or changing attributes in the target, such as processor registers. Thus, back-end section 22 manages the information about the target and implements the specific operations on the target. It comprises a target status management section 220 and a target memory access section 222. For this, it uses a “bare target backend” module 221L when no target agent is used (FIG. 2), or a “target agent back-end” module 221R if the target is accessed through target agent 29 (FIG. 1). These modules take into account the differences between e.g. a JTAG interface and a target agent, as far as data is concerned.

The transport back-end 23 is a small part of DebugServer 20 that generally manages the physical communication with the target. The communication itself 230 depends on the debugging mode, and more specifically on the ability to use the communication media on the target. For a user debugging mode, ChorusOS communications functionalities can be used, e.g. a transport back-end 231 based on UDP/IP or TCP/IP. For a system debugging mode, the communication mechanism must continue to work even if ChorusOS is stopped. For this, the debug agent will use the serial line in polling mode (without interrupts), as shown in 232. When the system is being debugged upon a crash at the core file level (233), the user communication is also invalid. Debug Server 20 will continue to serve the user debugging mode by transparently switching to the system debugging communication type. However, while the system is stopped, all user applications are stopped.

As already mentioned, the DebugServer 20 and generic debugger 11 may run in separate processes. When the generic debugger 11 invokes any Debug Server API, an inter-process communication (IPC) takes place. This inter-process communication is hidden by the API, i.e. is taken care of by the API itself, and not visible to the programmer using the API.

Section 21 implements the debug functionalities. It has to view OS objects on the target. The expression “target objects” here means any entity which a survey tool may need to read, possibly to (re)write, or to control. Unless otherwise indicated or suggested from the context, “target objects” more precisely refers to the view of these objects in section 21 of debug server 20. Thus, one may define:

an object model to view target objects,

a naming model to identify target objects in the host, and

an event model to notify survey tools about certain events.

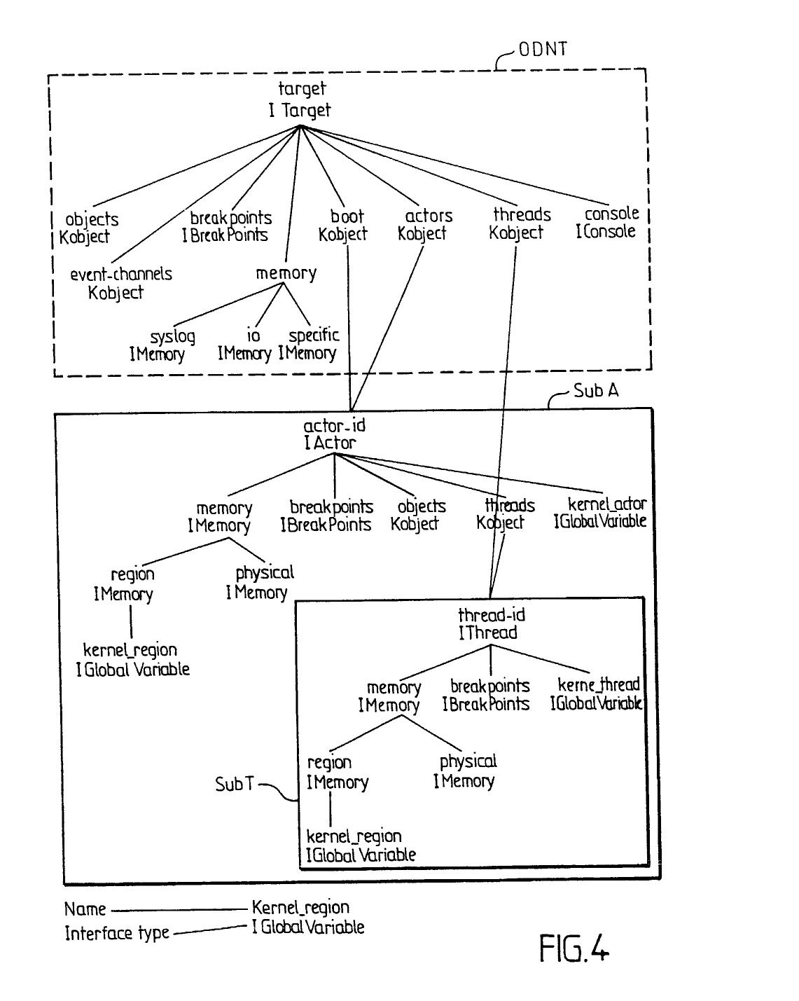

The objects in FIG. 4 generically represent OS entities such as actors, threads and so on (in ChorusOS). Some are defined to represent the target memory or I/O ports. Generally, these objects may be classified in three categories:

objects which have a physical representation in memory on the ChorusOS target, e.g. the “global variables”.

objects which are abstract, in the sense that no memory representation of them exists on the target. This is the case for breakpoints, targets, event channels.

objects which have a physical representation in memory on the ChorusOS target but for which Debug Server 20 provides a partial and/or adapted view of that representation. This is the case for actors, threads and memory regions.

The wording “target object” is used because the target is being aimed at. However, a “target object” may exist either in the Debug Server 20 or in the target T itself.

The object and naming models will be understood from FIG. 4, which shows an example of a generic Object Description and Naming Tree (ODN tree; ODNT in the figure). The ODN tree is a static reference tree, in which each node is generic. This is in contrast with the actual or dynamic object processing tree (DOP tree) to be described later on, in which certain nodes will mean e.g. a particular target or a particular actor. For any target, the tree also defines the naming rules to be used to define a particular target object, as it will be seen.

Certain objects in the ODN tree may have several instantiations, i.e. be used several times with different names or “-id”. For example, “Threads” is a container object, with potentially one or more particular instantiations as “Thread-id” objects.

Among these, the boot or any other actor, when so instantiated, will be submitted to the subtree in frame SubA of FIG. 4. Similarly, when instantiated either from the main tree or from tree SubA, a thread will be submitted to the subtree in frame SubT of FIG. 4. The differences between SubT and SubA comprise the lack of “objects” and “threads” and the substitution of “Kerne_Thread” for “Kernel_Actor”.

Finally, each node in the ODN tree is referred to a corresponding interface object, as it will be described next.

Program code corresponding to the ODN tree is located in 213. It is preferably associated with a set of XML files stored in the host, containing a representation of the ODN tree. The XML files may include other useful information. Preferably, an XML file is used as a database to record the current list of targets.

As noted, section 210 comprises the main debug APIs module 211, i.e. “browse”, “Debug”, “Event” and “Console”, and a module 212 implementing the management of the operations or methods related to the main debug actions.

The program code of modules 211 and 212 is based on an Interface Type tree, or ITy tree, an example of which is shown as ITyT in FIG. 5. The representation of the ITy tree is contained within a script in the Interface Definition Language (IDL) of the Object Management Group (OMG). The IDL script forms the basis for elaborating the code of modules 211 and 212, which thus in turn contains a representation of the ITy tree.

Here, “interface [type]” means the class or model used in IDL, while “interface [type] object” means a particular instance of an “interface [type]”. As indicated by square brackets, the word “type” is used optionally, when needed for clarity.

The ITy tree contains, as ITy objects, any object that the adapted debugger (11+12) needs to see, for delivering requests to the Debug Server 20. In FIG. 5, the different ITy objects for ChorusOS are specified together with their relation and hierarchy in the Ity tree. FIG. 5 also shows the relationship between each of the interfaces and the main APIs, noted B for BROWSE, D for DEBUG, E for EVENT and C for CONSOLE.

For ChorusOS, the Ity objects are for example:

“Kobject”, which, as the root of the tree, represents any object seen by a survey tool. This includes threads, actors, the memory, breakpoints but also any kernel object (whether they are abstract or have a memory layout). The methods associated with Kobject are generic, and comprise:

operations related to the object tree, and

operations related to values associated to the object.

“IMemory”, which provides operations to access the target memory in its broadest meaning, i.e. system-wide memory, or an actor memory. It provides operations to read or write the memory, the system IO ports and any memory device or type that a target can provide.

“IBreakPoints”, which controls the breakpoints which are set for an actor or a thread. It allows both global and perthread breakpoints to be to positioned.

“IExecutive”, which represents an execution entity. The execution entity is either the processor, a ChorusOS thread or an actor. The interface provides operations for controlling the execution entity; for example stopping or resuming execution.

“IActor”, which is used to represent an actor running on the target. It provides specific operations to control the execution of the actor.

“IThread”, which represents a thread or the processor. It provides operations for executing the program in single step mode. It defines name-value pairs to access the processor registers.

“ITarget”, which represents the entry point for managing the target and the objects it controls. It provides operations for launching a new actor. It also represents the processor to debug the global system.

“IEventChannel”, which represents an event channel. The event channel allows survey tools to receive events generated by the target agent, the DebugServer, the debugger or other tools using the Debug API.

“IGlobalVariable”, which represents a global variable of the system or of a system actor.

“IConsole” (optional), which represents the target console. It allows survey tools to implement a remote console for the target, so that target messages are reported on that remote console.

All Ity objects except “Kobject” are prefixed here with an “I”. The “I” is for convenience only, to avoid possible confusion with target objects having the same name, and does not appear in the IDL scripts.

Other slightly different Ity trees may be prepared for operating systems other than ChorusOS.

In accordance with the object-oriented approach, these ITy objects are similar to classes: methods (operations) provided in a given ITy object are inherited by derived ITy objects in the tree. For example, operations provided by the “Kobject” interface are available for all ITy objects; operations provided by the “IExecutive” ITy object are available on the ITy objects: IActor, IThread and ITarget.

The above mentioned IDL script (Appendix III) defines an example of the list of the ITy objects and operations (or “methods”) which can be related to such ITy objects, in accordance with the ITy tree. Since, in turn, each of the ITy objects is related to one or more of the main debug APIs 211, the IDL script is the basis for writing the main debug APIs 211. It also serves as a basis to write the method management section 212 which enables the IDL defined methods to be implemented, and accessed as defined in the ITy tree. While such an implementation using IDL is of interest, however, the invention is not limited thereto.

Thus, if e.g. the current action is BROWSING, the methods available are those implementing memory read functionality and those providing formatted binary representation of the ChorusOS target objects such as actors, threads, ports, regions and so on. Tools using the Debug API can format these binary representations as required. The console methods are also available, if a remote console is implemented on the host.

Debuggers normally uses all of the ITy objects except the “IConsole”, and the “IGlobalVariable” (to the extent an access to the Os archive has already been done). The “IGlobalVariable” is specific to monitoring and browsing tools. Tools other than debuggers will normally not use the “IBreak-Points”, “IExecutive”, “IActor” and “IThread”, as they are specific to debuggers.

Since IDL describes the interfaces and operations that a server provides, and IDL is both object-oriented and independent of the programming language, it enables to specify the organization of the APIs in terms of classes, types and operations, as well as giving semantics to operations that will be provided. It can be easily implemented in a number of programming languages.

Thus, the IDL script is compiled into a server portion (‘skeleton’) and one or more client portions (‘stubs’). The skeleton internally contains a representation of most of the IDL contents, e.g. the heritage of interfaces, and the operations or methods defined in the IDL script, in connection with each interface.

The OMG currently has mappings defined to the following languages: C, C++, Java, Ada, Smalltalk, Cobol. Men skilled in the art will note that no Object Request Broker (ORB) is required to define the interfaces with IDL. Thus it suffices to use a simple C mapping section, indicating the corresponding C types and operations that are provided by the Debug-Server debug library. Thereafter, sections 211 and 212 may be programmed in C or C++. Programming in Java is similar.

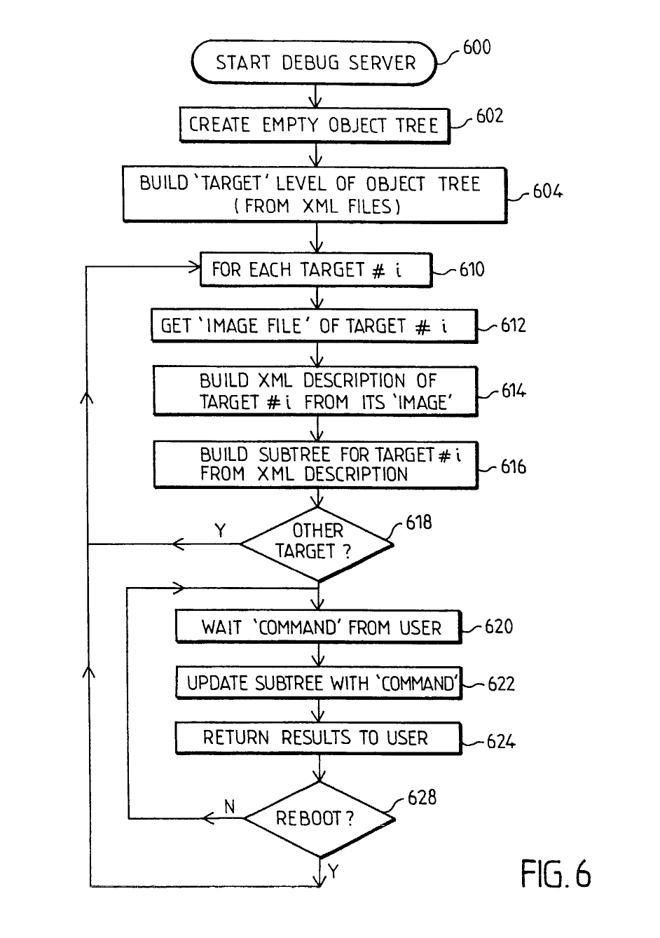

With reference to FIG. 6, the basic operation of debug server 20 will now be described. It starts (step 600) with the server 20 being just launched upon a first call to one of its main functions 2111 or 2113 (a debug process normally begins with browsing). The next step 602 is creating an empty “actual” or dynamic object processing tree (DOP tree). Then, step 604 creates the “target level” of the DOP tree. This uses the target(s) being accessible and an XML file used as a database to record the current list of targets.

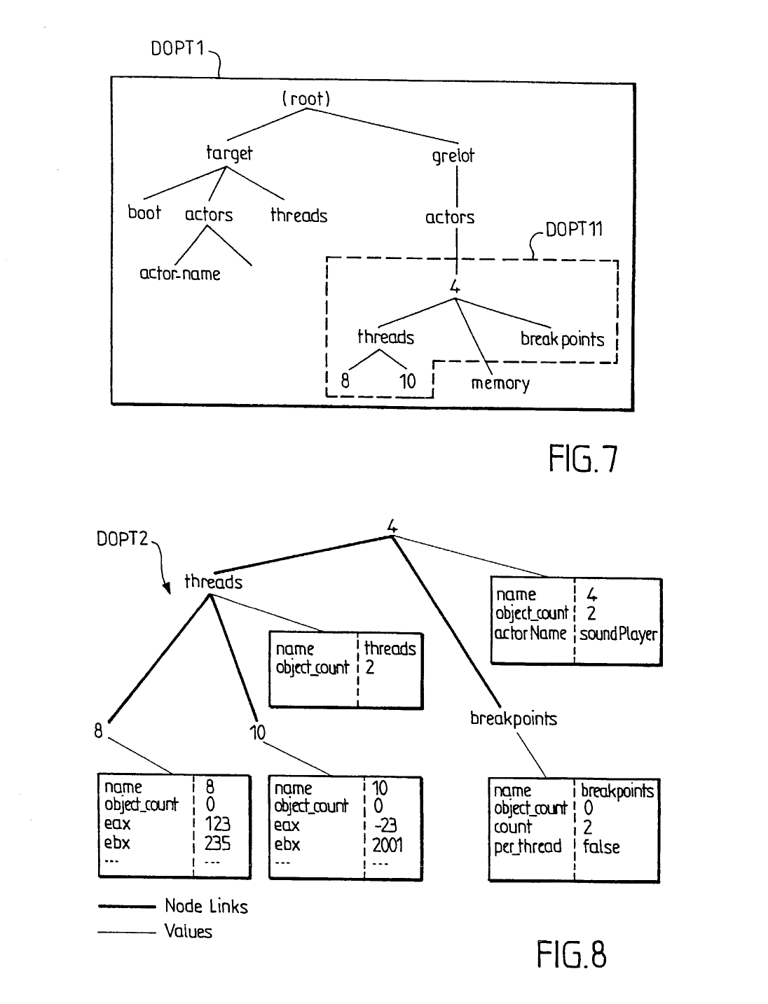

As shown in FIG. 7, the DOP tree (here DOPT1) starts from a “root”, and the target level includes e.g. a target named “grelot”. A dummy left branch is shown, just for illustrating the organisation of a generic “target”.

Then, the basic data concerning the or each target are acquired at steps 610-618. Step 612 comprises accessing the “OS archive” (“image file”) in the target, via the target debug agent 29, so that afterwards, the subtree of the target may be constructed from the OS archive at step 616.

This gives access, for example, to objects representing ChorusOS global variables, which have their name available in the symbol table of the “OS archive”.

Preferably, a target describing XML file is made from the OS archive at step 614, and the subtree is simply derived from that XML file at step 616 (to this effect, the OS archive must have been compiled with the option incorporating debug information).

This is repeated for each target, as indicated in steps 610 and 618.

Then, debugging per se occurs. At step 620, debug server 20 waits for a ‘command’ from the user, incoming through generic debugger 11, OS specific component 12, language-dependent API library 19, language-dependent front-end section 219, one of the main actions 211, and method management 212.

This is illustrated in Appendix II, in the case of debugging an actor.

After section 219, the user command will have a form completely independent of the generic debugger or other survey tool used in 11. It includes an unequivocal designation of an object, within all the objects Debug Server 20 will manage, give access to and represent.

Step 622 updates the subtree with the command, and step 624 returns the result to the user. The result may indicate that the command has failed, or give the result of the command.

If the system is not rebooted (by the command or by accident), the next step is again 620; otherwise, the next step is 610, at least for the target being re-booted, since the image file may have changed.

The ODN tree of FIG. 4 enables that a name is associated to each target object unequivocally, in the presence of a potentially very large number of target objects.

The DOP tree is constructed stepwise as a function of the user commands.

For example, in DOPT1 of FIG. 7, target “grelot” currently has its subtree actors with actor “4”, in turn including a subtree threads with threads “8” and “10”, and pending memory and breakpoints subtree.

The DOP tree is managed like a file system. Each object represents a node of the tree and it can potentially have sub-nodes. An object with sub-nodes is similar to a directory, those without are similar to a file (although, unlike files, these objects do not have contents). No node of the DOP tree can hold two sub-nodes with the same name. If they have different parent nodes, objects like actors and threads may have the same name.

Threads have their name unequivocally built with the target kernel local “thread id”, and actors have their name built with the target kernel local “actor id”. For the rest, module 215 of the Debug Server 20 is arranged to find unequivocal names automatically, as necessary.

Thus, the DOP tree of FIG. 7 constitutes firstly a “naming tree”. A root object is necessary to indicate the entry point of the tree. Under this root node, each target known by Debug Server 20 is represented by an object. Target objects are identified by the target name (which is given to Debug Server upon registration by the user of his target), e.g. “grelot”. A target node contains several sub-nodes: actor nodes are defined to hold the list of running actors, thread nodes are defined to represent the list of running threads.

Any target object is unequivocally designated by the list of names representing each node to be traversed to reach that target object in the tree. In other words, this list is specified on the form of a path, as for a file system path. Each name is separated by the slash (‘/’) or backslash (‘\’) character, indifferently. This list may be:

absolute to the root node (starting with the slash or backslash character), like path “/grelot/actors/4”, representing the actor 4 running on the target “grelot”, or

relative to a given node within the tree, like path “threads/8”, which, assuming this relative path is applied on the object returned with the previous path, gives access to the thread 8 thereof.

Other paths conventions may be applied, like the special name ‘. . ’ representing the parent node of the current node.

Accessing target objects is not enough, since information about them needs to be retrieved. In order to do so, each target object is supplemented with a set of attributes.

The possible attributes are generically defined for each nature of object in module 213. An attribute has the following characteristics:

(attribute) name, which is assumed to be unique within all the attribute names of a given node. However, attribute names is a different namespace from the object name namespace: It is possible to have an attribute name which is the same as an object name.

(attribute) value, which represents the information associated with the attribute.

(attribute) type, which indicates the format of the (attribute) value content, e.g. amongst integers, strings, pointers.

(attribute) read/write, which indicates whether the attribute value can be changed, or not. For example, attribute “object_count”, indicating the number of sub-nodes of a given node, cannot be changed and is read-only.

The objects designated in the DOP tree of FIG. 7 each have attributes, which are accessible to the survey tool. This is illustrated as an “Annotated Naming Tree”, DOPT2 in FIG. 8, which corresponds to a portion DOPT11 of tree DOPT1 in FIG. 7. In FIG. 8, each node is linked to a window showing some of its attributes and their values. Each node has at least two attributes named “name” and “object_count”. The “name” attribute indicates the name of the current node, and the “object_count” attribute indicates the number of sub-nodes held by the current node. Because nodes like “8” and “10” are used to represent threads, they have more attributes to indicate more information about the thread. Note also that “per_thread” is false in a breakpoint being not connected to a thread.

Debug server 20 thus can provide a survey tool with a set of target objects and information about such objects. The survey tool will invoke specific actions on these objects to control or affect the behaviour of these objects on the target.

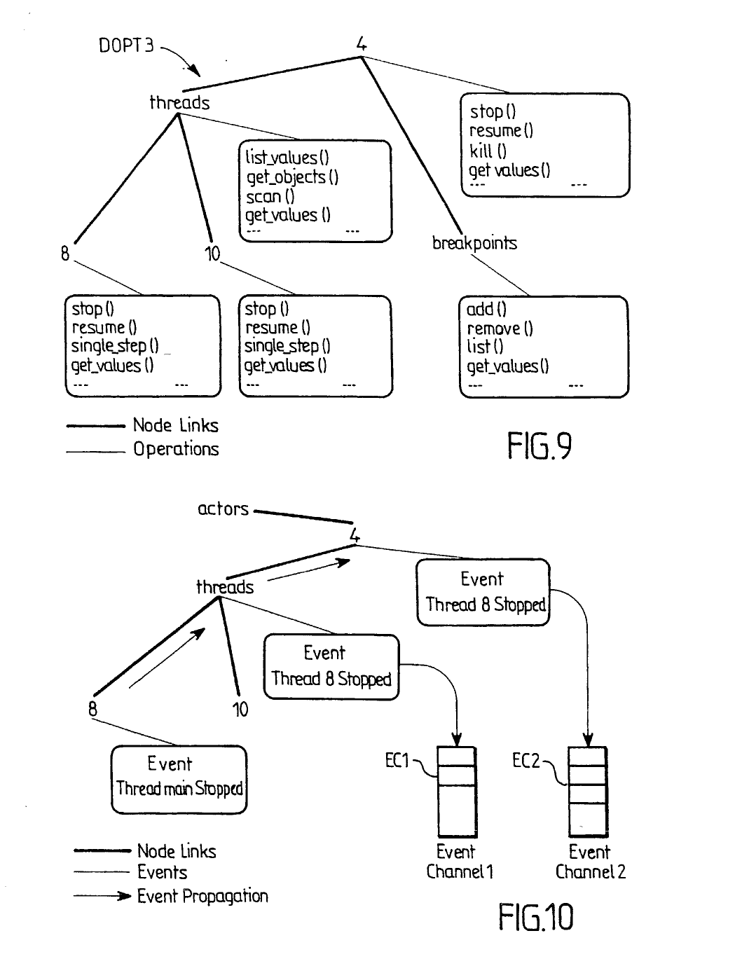

The set of operations or actions which are allowed on a given object depend on the object itself. FIG. 9 gives as DOPT3 an example of the operations available on the objects of DOPT2 in FIG. 8. Each node of DOPT3 (i.e. each object) is associated to an “[interface] type”. This “type” indicates the operations or “methods” which are available on the object.

It should now be reminded that:

these methods are defined in connection with the ITy objects in the ITy tree of FIG. 5, and

each node in the DOP tree is constructed from a generic node in the ODN tree of FIG. 4, which in turn refers to a corresponding Ity object in the Ity tree.

Accordingly, the methods attached to Kobject are available on all objects. These types of methods have a generic semantic. In general, they are related to the browsing of the actual object tree (i.e., looking for objects or retrieving values). This is the case for example for the “get_objects( )”, “scan( )”, “get-values( )” methods.

Thus, in FIG. 9, “threads” has child objects “B” or “10”; these have been constructed from “thread-id” in FIG. 4, which in turns points to Ity node “IThreads” in FIG. 5. Accordingly, scanning the Ity tree, child objects “8” or “10” have the methods of “Kobject” plus the methods of “IExecutive” plus the methods of “IThreads”. Note that “threads” in FIG. 4 only has the methods of Kobject.

The methods of “IExecutive” comprise “stop( )” and “resume( )”. According to the ITy tree of FIG. 5, they are inherited by both “IActors” and “IThreads”, thus being applicable to the nodes labeled “4”, “8” and “10” in FIG. 9. By contrast, the “single_step” operation is provided for “Ithreads”, not for “IActors”, and is not available for the actor “4”.

Similarly, “breakpoints” in FIG. 9 would have, with reference to “breakpoints” in FIG. 4 and then to “Ibreakpoints” in FIG. 5, the methods of “Kobject” plus the methods of “IBreakPoints”. Breakpoint nodes thus have specific operations to be able to insert or remove breakpoints. (Alternatively, “breakpoints” in FIG. 9 might have child objects constructed from a “breakpoint-id”—not shown—, as is done with “threads” and “thread-id” in FIG. 4).

The methods mentioned here are not exhaustive, and other operations than those of FIG. 9 are available, as indicated in Appendix III.

The interest of the DOP tree may now be understood. A list of objects under control of debug server 20 is available after step 618 (FIG. 6). These objects include the target, the threads and the actors; various actions can be applied to these objects, as in the following examples:

attach/detach:

inform me of all significant events related to this object

/ do not inform me;

stop/continue:

freeze this object in order to inspect its state

/ work as usual;

status query: stopped/working/alive/ . . . ;

state query: registers values for a thread, for example;

create/kill:

download an executable file to the target board, create an actor and main thread

/ effectively destroy the actor;

The above actions could be applied not only to actors and threads, but also to IPC ports for example. It could be useful to stop a thread, but to execute another one in the same actor; the same debug logic can be used to disable receipt of messages on one IPC port, while still receiving messages on another IPC port in the same actor.

Basically, the commands from the “adapted debugger” may include:

obtaining information related to the object, and the ability to change this information if necessary;

applying specific actions or operations to control or affect the behaviour of the object (the application or the system on the running target);

accessing a child object of the current object.

All this is selectively implemented by the above described methods. The interfaces in the interface tree correspond to the node types in the object description tree. They allow navigation within the actual target object tree, as well as specialized functions which perform specific actions on a given object of that tree: for example, set a breakpoint, stop a thread or read the memory. All these actions are contextual. The same action applied on two different objects, may provide different results or may have different semantics.

The event and event channel will now be described. Generally, the concept of event is described, inter alia, in U.S. Pat. No. 5,872,909 (“Logic analyzer for software”).

In this invention, an “event” indicates some fact(s) which has happened at some time, and at some place, generally on the target. Events are an asynchronous notification mechanism back from the target to the host, with the purpose of notification.

Survey tools will use the Event main API to be notified about some general purpose events raised by the target or DebugServer. In general, debuggers will use this API after a program is started or re-started to be notified of a modification of the state of that program (death, breakpoint hit, thread signalled).

In the above described context, this means that survey tools must also be informed about the changes of the state of certain objects on the target.

Since the list of the events related to each target object would be quite long, a few only will be considered: for example, “creation”, “modification”, “destruction” are generic events which apply to threads, as well as for memory areas used for storage of message queues (waiting to be consumed by a process or actor). Some other events are specific, such as breakpoint hitting, exception hitting, system call execution.

An example of the relation between events and methods is illustrated in Appendix I.

The code for the event model is located in the target status management section 220 of FIG. 3A.

In response to a request to receive events from a survey tool, the Debug Server will create an event channel, in which certain events will be queued. The event channel has basically two purposes: it gives access to events and it allows control of which events are going to be received in the event channel. In general, each survey tool will have its own event channel.

When the target agent sends an event (related to a target object), the DebugServer identifies the corresponding target object in the actual target object tree (FIG. 7), and raises the event on the corresponding object. Thus, events may be raised on thread objects, others on actors, and some on the object representing the target. The DebugServer always unequivocally identifies the object in the tree, and hence its name, because the target itself is represented by an object.

When an event is raised on an object, it is allocated a unique “event_id”; then, it is propagated as follows:

first, the event is sent to each event channel which is connected to the object,

second, any object which holds an event of a given nature will propagate that event to its parent object, if that object is entitled to propagate events of that nature. This is repeated until the event is held by an object not entitled to propagation thereof (of course, the root object propagates no event). In other words, each object of the DOP tree has an “event mask” which indicates the events that should be propagated. Together, the event masks define event propagation rules.

Since the same event channel can be attached to several objects, the same event could be propagated to this event channel several times. To avoid this duplication, events are only posted once for a given event channel (duplication is avoided using the event_id).

FIG. 10 illustrates a practical example of event propagation. A first event channel EC1 is connected to the “threads” node; a second event channel EC2 is connected to the node “4”.

Thread “8” was recently stopped and the Debug Agent 29 has notified Debug Server 20 about this event. Debug Server 20 has generated an event on the node “8” of FIG. 10. This event is propagated to the “threads” node and then to the actor node “4”, assuming the event propagation mask allows this propagation. The first event channel EC1 receives the event from the “threads” node. The second event channel EC2 receives the event from the node “4”.

Assuming now that node “4” blocks the propagation of the “thread stopped” event, the event is not propagated to the actors node.

This event propagation mechanism has several advantages:

A debugger which is going to debug an actor just has to connect an event channel on the actor's node. By doing so, it receives all the events generated by threads, breakpoint changes, related to the actor to be debugged.

A debugger can block all the events at the actor node level, thus avoiding propagation of the events, which will be handled by the debugger.

A debugger should also connect the event channel to the actors node in order to receive events notifying the death of actor.

A survey tool or debugger can connect an event channel to the target root and receive all the propagated events.

An example of the Console and Miscellaneous main API 2119 will now be considered. In general ChorusOS uses the console to print messages. These messages are generated by ChorusOS as a primary debugging facility: “printfs” (the “Print on console” C command) are inserted into the code to trace the behaviour of the system. In a host/target environment, the physical console which is used by the target may not be appropriate (in most cases because it is physically far from the host). Also some targets have only one physical serial line as the communication interface, and the debug connection and the console IO must share it. To avoid problems with the console, the ChorusOS Debug API defines a particular API which allows survey tools to emulate a console for ChorusOS, optionally.

Thus, the described system provides:

an open debugging environment, whose interconnection with generic debuggers or other survey tools necessitates only language adapting modules,

a debugging environment, capable of operating either in direct mode, or through a target debug agent,

a debugging environment using XML files as target object definitions, and producing XML files to define the target status, thereby facilitating the connection with other system tools, in particular system configuration tools.

This invention is not restricted to the embodiment as disclosed. Although it extensively refers to ChorusOS, it may be applied to other operating systems.

The above description refers to the minimal debug agent, which is preferred, since it is often desirable to have the smallest possible debug code running on the target. However, the proposed debug architecture is flexible as to the code running on the target, which may range from providing only the basic services needed to implement the debug APIs, to expanded configurations, in which the target agent 29 performs most of the debugging actions.

An advantage of the minimal debug agent is that it does not need specific hardware such as the JTAG or BDM interfaces, which are optional. By contrast, many operations are performed by the Debug Server. For example, when a breakpoint is hit, the target is stopped and the DebugServer determines whether or not it is to be restarted. In certain cases, a better efficiency may be obtained by moving certain complex operations from the Debug Server 20 to the Target Agent 29. For example, the management of conditional breakpoints (per-actor breakpoint, per-thread breakpoint, . . . ) can be transferred into the Target Agent 29, thus reducing the communication between the Debug Server 20 and the target T. As another example, when browsing ChorusoS objects, the Debug Server 20 reads the kernel structures piece by piece, and all scanning is carried out on the host H0; alternatively, the specific object browsing code can run in the target debug agent 29 instead of on the host. In other words, there is no fixed division of the functionalities between the Debug Server 20 and the Target Debug Agent 29. Most of the Debug code usually executed on the host could be configured to run on the target.

It will now be understood inter alia that the invention provides for an organized view of a target, which may be effective in various target conditions, through the interfaces of FIG. 2, and/or through the target agent of FIG. 1. The extent of the tasks devoted to the target agent may also be selected as desired. Furthermore, the operation is very flexible, in terms of choice of the survey tool being used, and of the programming language being involved.

This invention also covers the proposed software code itself, especially when made available on any appropriate computer-readable medium. The expression “computer-readable medium” includes a storage medium such as magnetic or optic, as well as a transmission medium such as a digital or analog signal. The software code basically includes the code for use in the debug server, as well as the code for use in the target agent, and precursors of such codes, e.g. written in IDL. The invention also encompasses the combinations of such codes with language dependent and/or hardware dependent modules.

[image]

[image]

[image]

[image]

[image]

[image]

[image]

[image]

[image]

[image]

What is claimed is:

1. A computer system providing an open survey tool environment, comprising:
a target (T1) and a host (H0),
in said host, a survey tool (11, 12), capable of issuing commands to obtain information on said target,
said host further having a server (20), capable of communicating with said target (T1), said server having:
a server module (21) for elaborating and maintaining an object-oriented representation of the target condition, and
a survey tool interface (219), including an adapting module for adapting said survey tool to said object oriented representation.

2. A computer system according to claim 1, wherein said survey tool interface (219) is arranged for answering at least some of said commands from said survey tool (11,12) with information derived from said object-oriented representation of the target condition.

3. A computer system according to claim 1, wherein said object-oriented representation comprises target objects, with each target object having attributes for storing corresponding target condition data, and with a correspondence between each target object and corresponding available operations.

4. A computer system according to claim 3, wherein said operations comprise first operations for elaborating and maintaining said object-oriented representation, and second operations for acquiring and accessing attributes of target objects.

5. A computer system according to claim 3, wherein said survey tool interface (219) is arranged for converting said survey tool commands into operations available in said object-oriented representation.

6. A computer system according to claim 3, wherein said server module (21,215) is arranged for elaborating and maintaining said object-oriented representation in accordance with a dynamic tree structure (DOPT), in which said attributes are attached to a corresponding target node or a sub-node thereof.

7. A computer system according to claim 6, wherein first level sub-nodes of target nodes are selected within a group of generic target objects comprising at least: boot, processes or actors, threads, breakpoints and memory.

8. A computer system according to claim 1, wherein said server module (21) comprises:
first data (213), defining a preselected set of target objects, comprising generic target objects, as well as instances of at least some of the generic target objects, a respective preselected set of attributes for each of the target objects, and a rule for uniquely designating the target objects, and
said server module (215) is arranged for elaborating and maintaining said object-oriented representation from said first data.

9. A computer system according to claim 8, wherein said first data (213) is arranged as a generic tree structure (ODNT), and said server module (215) is arranged for elaborating and maintaining said object-oriented representation by filling in an actual tree structure (DOPT) derived from said generic tree structure.

10. A computer system according to claim 8, wherein said first data (213) is arranged to maintain a correspondence between each target object in said preselected set thereof and operations available to this target object, and said server module (215) implements that correspondence for each node of said actual tree structure (DOPT).

11. A computer system according to claim 10, wherein said server module (21) further comprises:
second data (211;212) defining a correspondence between a plurality of interface types and a set of operations for each such interface type, and
said first data (213) comprises a reference to said second data for each target object in said preselected set thereof.

12. A computer system according to claim 11, wherein said second data (213) is arranged as another tree structure (ITyT), in which each node inherits the set of operations for its parent node.

13. A computer system according to claim 12, wherein said operations comprise first operations for elaborating and maintaining said object-oriented representation, and second operations for acquiring and accessing attributes of target objects, and said another tree structure (ITyT) has a root (Kobject), with at least certain of the first operations corresponding to that root.

14. A computer system according to claim 8, wherein said first data (213) is represented by a set of XML files.

15. A computer system according to claim 3, wherein said operations comprise Browsing operations, Debugging operations and Event operations.

16. A computer system according to claim 3, wherein said operations comprise Event-related operations, said Event-related operations comprising operations for relating incoming target events to target objects, operations for controlling propagation from a target event held by an object towards the root in said dynamic tree structure, and operations for selectively attaching Event channels to target objects in said dynamic tree structure, so that when a target object having an attached event channel receives an event, that event is included into its event channel.

17. A computer system according to claim 1, wherein said survey tool interface (219), is arranged for answering said commands according to at least one application language.

18. A computer system according to claim 1, wherein said survey tool comprises a generic survey tool (11) and an OS specific component (12).

19. A computer system according to claim 1, wherein said target comprises a target agent (29), acting as a server for said server module (20) as a client.

20. A computer system according to claim 1, wherein said target has a target operating system, with a stored local reference version thereof, and said operations comprise reading said stored local reference version of the target operating system.

21. A computer system according to claim 1, wherein said target has a target operating system, capable of writing a core file upon system error, and said operations comprise reading said core file in the target.

22. A computer system according to claim 1, wherein said target and said host are installed on different computer stations, interconnected with each other.

23. A computer system according to claim 22, wherein said different computer stations are interconnected via a serial line.

24. A computer system according to claim 22, wherein said different computer stations are interconnected via a physical interface having the potentiality of stopping and restarting the target station processor, and said operations include operations directed to that physical interface.

25. A server software for use in surveying a target in a computer system, comprising code adapted to implement said server module (21) and survey tool interface (219) of anyone of claim 1.

26. A target agent software for use in surveying a target in a computer system, comprising code adapted to implement said target agent (29) of claim 19.

27. A method of surveying a target in a computer system, said method comprising the steps of:
a) providing a survey tool (11,12) in a host (H0),
b) providing said host with a server (20), capable of communicating with said target (T1),
c) in said server:
c1) elaborating and maintaining an object-oriented representation of said the target condition, and
c2) providing a survey tool interface (219), capable of adapting said survey tool to said object oriented representation.

28. The method of claim 27, wherein said survey tool interface (219) is arranged for answering commands from said survey tool (11,12) with information derived from said object-oriented representation of the target condition.

29. The method of claim 27, wherein said object-oriented representation comprises target objects, with each target object having attributes for storing corresponding target condition data, and with a correspondence between each target object and corresponding available operations.

30. The method of claim 29, wherein said operations comprise first operations for elaborating and maintaining said object-oriented representation, and second operations for acquiring and accessing attributes of target objects.

31. The method of claim 29, wherein said survey tool interface (219) is arranged for converting survey tool commands into operations available in said object-oriented representation.

32. A method according to claim 29, wherein step c1) comprises elaborating and maintaining said object-oriented representation in accordance with a dynamic tree structure (DOPT), in which said attributes are attached to a corresponding target node or a sub-node thereof.

33. A method according to claim 32, wherein first level subnodes of target nodes are selected within a group of generic target objects comprising at least: boot, processes or actors, threads, breakpoints and memory.

34. A method according to claim 29, wherein step c1) comprises:
storing a preselected set of target objects, comprising generic target objects, as well as instances of at least some of the generic target objects, a respective preselected set of attributes for each of the target objects, and a rule for uniquely designating the target objects, and
elaborating and maintaining said object-oriented representation from said stored preselected set of target objects.

35. A method according to claim 34, wherein said preselected set of target objects is arranged as a generic tree structure (ODNT), and step c1) comprises elaborating and maintaining said object-oriented representation by filling in an actual tree structure (DOPT) derived from said generic tree structure.

36. A method according to claim 35, wherein said preselected set of target objects (213) is arranged to maintain a correspondence between each target object in said preselected set thereof and operations available to this target object, and step c1) implements that correspondence for each node of said actual tree structure (DOPT).

37. A method according to claim 36, wherein step c1) further comprises:
storing a correspondence between a plurality of interface types and a set of operations for each such interface type, and
providing each object in said preselected set of target objects with a reference to an interface type.

38. A method according to claim 37, wherein said correspondence, between a plurality of interface types and a set of operations for each such interface type, is arranged as another tree structure (ITyT), in which each node inherits the set of operations for its parent node.

39. A method according to claim 38, wherein said operations comprise first operations for elaborating and maintaining said object-oriented representation, and second operations for acquiring and accessing attributes of target objects, and said another tree structure (ITyT) has a root (Kobject), with at least certain of the first operations corresponding to that root.

40. A method according to claim 29, wherein said operations comprise Browsing operations, Debugging operations and Event operations.

41. A method according to claim 29, wherein said operations comprise Event-related operations, said Event-related operations comprise operations for relating incoming target events to target objects, operations for controlling propagation from a target event held by an object towards the root in said dynamic tree structure, and operations for selectively attaching Event channels to target objects in said dynamic tree structure, so that when a target object having an attached event channel receives an event, that event is included into its event channel.

42. A method according to claim 27, wherein step b) comprises providing said target with a target agent (29).

43. A method according to claim 27, wherein said target has a target operating system, capable of writing a core file upon system error, and step b) comprises reading said core file in the target.

44. A method according to claim 27, wherein said target has a physical interface having the potentiality of stopping and restarting the target processor, and step b) includes accessing that physical interface.

45. A server software for use in surveying a target in a computer system, comprising code adapted to implement step c) of claim 27.
